(19) United States
(12) Patent Application Publication
(10) Pub. No.: US 2026/0204040 A1
(43) Pub. Date: Jul. 16, 2026

(54) INFORMED FEATURE EXTRACTION FOUNDATION MODEL

(71) Applicant: Schlumberger Technology Corporation, Sugar Land, TX (US)

(72) Inventors: Shirui Wang, Houston, TX (US); Haibin Di, Houston, TX (US); Hiren Maniar, Houston, TX (US); Arvind Sharma, Houston, TX (US)

(21) Appl. No.: 19/446,524

(22) Filed: Jan. 12, 2026

Related U.S. Application Data
(60) Provisional application No. 63/745,185, filed on Jan. 14, 2025.

(51) Int. Cl. G06V 10/26; G01V 1/30; G06V 10/25; G06V 10/77; G06V 10/82; G06V 20/64

(52) U.S. Cl. CPC G06V 10/26; G06V 10/25; G06V 10/7715; G06V 10/82; G06V 20/64; G01V 1/301

(57) ABSTRACT

A method implements an informed feature extraction foundation model. The method involves processing a reference image and a target image using a feature encoder model to generate feature encoder output. The method further involves processing a reference mask using a prompt encoder model to generate a prompt encoder output. The method further involves processing the feature encoder output and the prompt encoder model output using a mask decoder model to generate a target mask.

### CROSS REFERENCE TO RELATED APPLICATIONS

This application claims the benefit of U.S. Provisional Application 63/745,185, filed Jan. 14, 2025, which is hereby incorporated by reference herein.

### BACKGROUND

Large language models (LLMs) and large vision models (LVMs) have demonstrated the capability of using large neural networks and large volumes of data for more general and diverse tasks, presenting the potential of building foundation models (FMs) for various downstream tasks. With the strong feature of engineering and abstraction capability, deep neural networks may be applied to various seismic data processing and interpretation tasks in the past years. Seismic interpretation tasks are often formulated as a semantic segmentation problem, where the output may be a multidimensional mask with each element classified into one category and requiring pixel level accuracy, such as fault picking, salt body picking, first break picking, horizon picking, and facies classification. A model may be trained with labeled datasets on predefined classes to understand the targeted geophysical features and differentiate the features from the background or undefined seismic patterns. The models may be used within a closed set of categories and may not extend or be reused when new tasks or categories arrive.

### SUMMARY

In general, in one or more aspects, the disclosure relates to a method that implements an informed feature extraction foundation model. The method involves processing a reference image and a target image using a feature encoder model to generate feature encoder output. The method further involves processing a reference mask using a prompt encoder model to generate a prompt encoder output. The method further involves processing the feature encoder output and the prompt encoder model output using a mask decoder model to generate a target mask.

In general, in one or more aspects, the disclosure relates to a system that includes at least one processor and an application that executes on the at least one processor. Executing the application performs processing a reference image and a target image using a feature encoder model to generate feature encoder output. Executing the application further performs processing a reference mask using a prompt encoder model to generate a prompt encoder output. Executing the application further performs processing the feature encoder output and the prompt encoder model output using a mask decoder model to generate a target mask.

In general, in one or more aspects, the disclosure relates to a non-transitory computer readable medium including instructions executable by at least one processor. Executing the instructions performs processing a reference image and a target image using a feature encoder model to generate feature encoder output. Executing the instructions further performs processing a reference mask using a prompt encoder model to generate a prompt encoder output. Executing the instructions further performs processing the feature encoder output and the prompt encoder model output using a mask decoder model to generate a target mask.

Other aspects of one or more embodiments may be apparent from the following description and the appended claims.

### BRIEF DESCRIPTION OF DRAWINGS

FIG. 1.1 and FIG. 1.2 show diagrams in accordance with the disclosure.

FIG. 2 shows a method in accordance with the disclosure.

FIG. 3 and FIG. 4 show examples in accordance with the disclosure.

FIG. 5.1 and FIG. 5.2 show computing systems in accordance with the disclosure.

Similar elements in the various figures may be denoted by similar names and reference numerals. The features and elements described in one figure may extend to similarly named features and elements in different figures.

### DETAILED DESCRIPTION

The disclosure describes an interpretation of a computational workflow that may be used with subsurface data in which the target of a segmentation may be defined using one reference example to the model. The model directly digests the reference sample and segments the same feature from three-dimensional target data.

The workflow enables a prompt like user experience. The model understands the features of the target segmentation to generate a three-dimensional mask that segments a three-dimensional volume (e.g., of subsurface data). The model is used in a direct inference and dynamic way, which eliminates the need for further tuning.

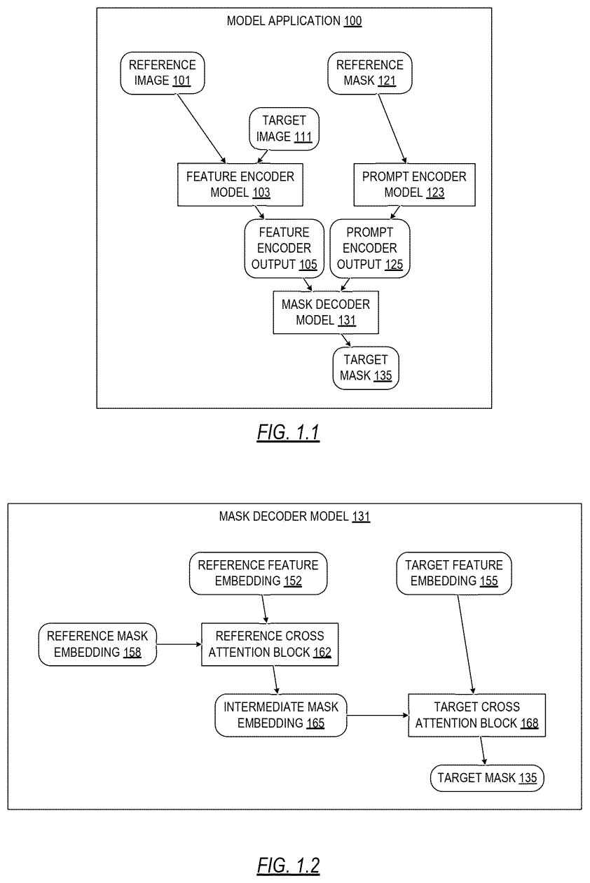

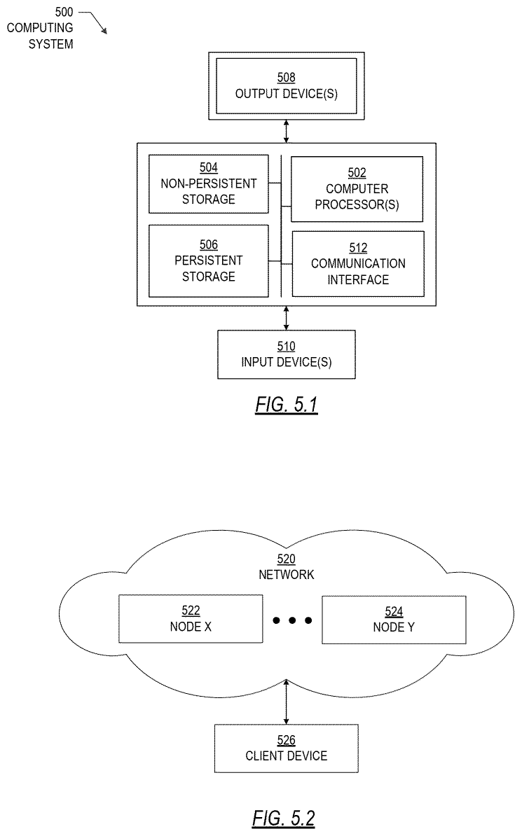

Turning to FIG. 1.1, the model application (100) is a collection of components that implement an informed feature extraction foundation model. The model application (100) processes the reference image (101), the target image (111), and the reference mask (121) to generate the target mask (135). The model application (100) may execute on and incorporate the hardware and software components of the computing system (500) of FIG. 5.1.

In the context of seismic data processing the model application (100) may be part of a system that processes volumes of subsurface data to identify geophysical features within the volume of subsurface data. The features may include reservoirs of subsurface fluids. The system utilizing the model application (100) may identify characteristics of the fluids (or other features), including the amount, size, type, value, etc.

The reference image (101) is a data structure representing a two-dimensional slice extracted from a three-dimensional volume. The reference image (101) may be one of multiple slices extracted from the volume. In an embodiment, the volume may be of seismic subsurface data and the reference image (101) may represent a cross section of the subsurface of the Earth, that captures capturing information about geological structures and stratigraphy. Features in the reference image (101) may include seismic reflections showing the boundaries between different geological layers. The reflections may be generated by the contrast in acoustic impedance between layers of the subsurface of the Earth. The brightness or intensity of the reflections indicates the strength of the seismic signal, which can be related to the properties of the subsurface materials, including density and elasticity. Structural features like faults, folds, and other geological structures may be visible in the image, providing insights into the tectonic history and potential locations of resources like subsurface fluids, including hydrocarbons, oil, gas, etc.

The reference image may be a two-dimensional array and represent a slice of a three-dimensional seismic volume. Each element in the array corresponds to a pixel, which contains information about the seismic reflections, such as amplitude and phase, across different channels of a particular location in the volume. The reference image (101) may have multiple channels of data for each pixel and each of the pixels may have the same number of channels within the reference image (101). For seismic data, each channel may represent a different attribute or measurement related to the seismic waves. For example, a seismic system may record data from thousands of geophones simultaneously, with each geophone providing a separate channel of data. The channels may include various attributes such as amplitude, frequency, phase, etc., which are used to create detailed images of the subsurface.

The target image (111) may be another data structure representing a two-dimensional slice extracted from the three-dimensional volume. The target image (111) and the reference image (101) may be different slices from the same volume.

The feature encoder model (103) is a machine learning model that processes the reference image (101) and the target image (111) to generate the feature encoder output (105). The feature encoder model (103) may process the reference image (101) and the target image (111) independently.

The feature encoder output (105) is the output from the feature encoder model (103). Separate outputs may be generated for each of the reference image (101) and the target image (111). An output from the feature encoder model (103) may be a feature embedding generated for the image that was input to the feature encoder model (103). For example, the feature encoder output (105) may include a reference feature embedding generated as output for the reference image (101) and may include a target feature embedding generated as an output responsive to the target image (111).

The reference mask (121) is a data structure that may be another two-dimensional array of the same dimensions as the reference image (101). The reference mask (121) identifies one or more features within the reference image (101). Each element in the array of the reference mask (121) may correspond to a pixel in the reference image (101) to indicate whether the pixel is part of a specific feature. The feature may be a geofeature, such as a fault, a horizon, etc. The reference mask (121) may use binary values (e.g., 0 for background and 1 for the feature) or categorical values if multiple features are being identified.

The prompt encoder model (123) is a machine learning model that processes the reference mask (121) to generate the prompt encoder output (125). The prompt encoder model (123) utilize a convolutional neural network to process the reference mask (121) and generate the prompt encoder output (125).

The prompt encoder output (125) is the output from the prompt encoder model (123). The prompt encoder output (125) may include a reference mask embedding that was generated by the prompt encoder model (123) for the reference mask (121). The prompt encoder output (125). may have the same resolution but a different number of channels as compared to the feature encoder output (105). For example, the reference feature embedding and target feature embedding of the feature encoder output (105) may each have the same resolution and same number of channels, but the reference mask embedding of the prompt encoder output (125) may have the same resolution with a different number of channels.

The mask decoder model (131) is a machine learning model that processes the feature encoder output (105) and the prompt encoder output (125) to generate the target mask (135). The mask decoder model (131) may incorporate multiple transformer models to process the feature encoder output (105) and the prompt encoder output (125) using multiple layers of self-attention and cross attention. A version of the mask decoder model (131) is further described with FIG. 1.2.

The target mask (135) is a data structure that is a two-dimensional array with the same dimensions as the target image (111). The target mask (135) identifies the same features in the target image (111) that the reference mask (121) identifies in the reference image (101).

Turning to FIG. 1.2, the mask decoder model (131) may be a component of the model application (100) of FIG. 1.1. The mask decoder model (131) processes the reference feature embedding (152), the target feature embedding (155), and the reference mask embedding (158) to generate the target mask (135).

The reference feature embedding (152) may be a part of the feature encoder output (105) that was generated by the feature encoder model (103) in response to the reference image (101). The reference feature embedding (152) may identify features within the reference image (101). The reference feature embedding (152) is an input to the reference cross attention block (162).

The target feature embedding (155) may be another part of the feature encoder output (105) that was generated by the feature encoder model (103) in response to the target image (111). The target feature embedding (155) may identify features within the target image (111) that are similar to the features identified by the reference feature embedding (152) for the reference image (101). The target feature embedding (155) is an input to the target cross attention block (168).

The reference mask embedding (158) may be the prompt encoder output (125) that was generated by the prompt encoder model (123) in response to the reference mask (121). The reference mask embedding (158) may identify features within the reference mask (121). The reference mask embedding (158) is an input to the reference cross attention block (162).

The reference cross attention block (162) is a portion of the mask decoder model (131) that performs cross attention between the reference mask embedding (158) and the reference feature embeddings (152) to generate the intermediate mask embedding (165). With the reference cross attention block (162), the reference mask embedding (158) may be used to query the reference feature embedding (152) and generate the intermediate mask embedding (165).

The intermediate mask embedding (165) is the output of the reference cross attention block (162). The intermediate mask embedding (165) me identify features from the reference feature embedding (152) that relate to reference mask embedding (158). The intermediate mask embedding (165) is an input to the target cross attention block (168).

The target cross attention block (168) is a portion of the mask decoder model (131) that performs cross attention between the intermediate mask embedding (165) and the target feature embeddings (155) to generate the target mask (135). With the target cross attention block (168), the intermediate mask embedding (165) may be used to query the target feature embedding (155) and generate the target mask (135).

The target mask (135) is an output of the mask decoder model (131) generated by the target cross attention block (168). The target mask (135) identifies features in the target image (111) that are similar to features the reference mask (121) identifies in the reference image (101) of FIG. 1.1.

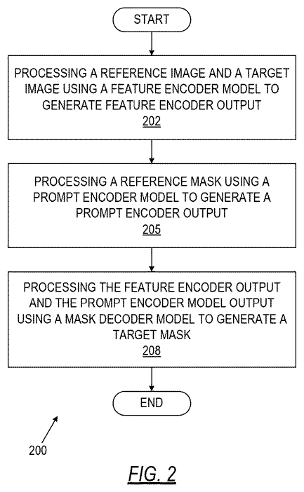

FIG. 2 shows a flowchart of a method implementing an informed feature extraction foundation model. The method of FIG. 2 may be implemented using the system of FIG. 1.1 and FIG. 1.2, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 2, the process (200) may be used to identify targeted features in a volume using a reference image from the volume and a reference mask corresponding to the reference image. The process (200) may include multiple steps (e.g., steps (202) through (210)) that may execute on the components described in the other figures, including those of FIG. 1.1 and FIG. 1.2.

Step (202) includes processing a reference image and a target image using a feature encoder model to generate feature encoder output. The feature encoder output may include a reference feature embedding generated for the reference image and a target feature embedding generated for the target image. For a given image that is input to the feature encoder model, the feature encoder model may split the image into a sequence of smaller images, convert the sequence of smaller images into a sequence of tokens, and process the sequence of tokens with a transformer model. The transformer model (of the feature encoder model) that processes the sequence of tokens may be an encoder model that uses self-attention to process the sequence of tokens generated from the image and generate a sequence of feature embeddings as an output.

Processing the reference image and the target image using the feature encoder model to generate feature encoder output may include generating a reference feature embedding from the reference image with the feature encoder model using self-attention. Self-attention weighs the importance of different regions of the image by calculating attention scores for each region, i.e., for the tokens and embeddings representing the regions of the image. Attention scores are calculated by comparing query and key vectors for each region, determining how much focus each region should receive based on the similarity between query and key vectors. Value vectors are then weighted by the attention scores to produce the final output for each region. The feature encoder model includes multiple attention heads that each perform self-attention, capturing various aspects of the image simultaneously. The multi head self-attention mechanism enhances the ability of the model to understand complex patterns and relationships within the image.

Processing the reference image and the target image using the feature encoder model to generate feature encoder output may also include generating a target feature embedding from the target image with the feature encoder model using self-attention. The target image is processed by the same feature encoder model using the same weights, parameters, attention heads, etc., as the reference image.

Step (205) includes processing a reference mask using a prompt encoder model to generate a prompt encoder output. The prompt encoder model generates a prompt encoder output that has the same spatial dimensions as the output of a feature encoder model but may have different feature or channel dimensions.

Processing the reference mask using the prompt encoder model to generate the prompt encoder output may include generating a reference mask embedding from the reference mask with the prompt encoder model using a convolutional neural network. A convolutional neural network of the prompt encoder model may operate by applying a series of convolutional layers to the reference mask. Each convolutional layer may include filters that are scanned across the reference mask, detecting various features such as edges, textures, patterns, etc. Filters produce feature maps that highlight the presence of specific features at different spatial locations within the reference mask. The output of each convolutional layer is passed through an activation function, which may be a rectified linear unit (ReLU), to introduce nonlinearity. Pooling layers may follow, reducing the spatial dimensions of the feature maps while retaining the feature information from the reference mask to form the reference mask embedding.

Step (208) includes processing the feature encoder output and the prompt encoder output using a mask decoder model to generate a target mask. The mask decoder model may use multiple encoder decoder transformer models to generate the target mask. An encoder decoder transformer model operates by first using an encoder to process the input data. The encoder includes multiple layers of self-attention and feed forward neural networks, which transform the input into a set of continuous representations. The continuous representations are then passed to the decoder, which also includes multiple layers of self-attention, cross attention, and feed forward neural networks. Cross attention operates by using query and value vectors from the target sequence (decoder input) and key vectors from the source sequence (encoder output). Cross attention focuses on relevant parts of the encoder output while generating the target mask. The decoder generates the output by attending to the encoder representations and previously generated outputs, producing the final target mask.

Processing the feature encoder output and the prompt encoder output using the mask decoder model to generate the target mask may include querying the reference feature embedding with the reference mask embedding to generate an intermediate mask embedding using a reference cross attention block in the mask decoder model. The querying process involves using the reference mask embedding as the query and the reference feature embedding as the key and value. The reference cross attention block calculates attention scores by comparing the query with the key, determining the relevance of each part of the reference feature embedding. Attention scores are then used to weight the value vectors, producing a weighted sum that forms the intermediate mask embedding. The intermediate mask embedding captures the relevant features from the reference feature embedding, guided by the reference mask embedding.

Processing the feature encoder output and the prompt encoder output using the mask decoder model to generate the target mask may include querying the target feature embedding with an intermediate mask embedding to generate the target mask using a target cross attention block in the mask decoder model. The querying process involves using the intermediate mask embedding as the query and the target feature embedding as the key and value. The target cross attention block calculates attention scores by comparing the query with the key, determining the relevance of each part of the target feature embedding. Attention scores are then used to weight the value vectors, producing a weighted sum that forms the target mask. The target mask captures the relevant features from the target feature embedding, guided by the intermediate mask embedding.

The process (200) may further include generating a plurality of images from an input volume. The plurality of images comprises the reference image and the target image. Generating the images from the input volume may involve slicing the input volume along specific planes or axes to create two-dimensional representations. Each slice corresponds to a different region within the input volume, capturing various features and details. The reference image and the target image may be selected from the slices.

The process (200) may further include generating a plurality of images from an input volume. The input volume comprises a three-dimensional view of subsurface data. The input volume may be obtained through advanced imaging techniques such as seismic surveys, which capture detailed information about the geological formations beneath the surface of the Earth. The system may create multiple images that represent different slices or perspectives of the subsurface structures of the area of interest represented by the input volume. The images may include information of potential resources and geological hazards.

The process (200) may further include generating an output volume from a plurality of images and a plurality of masks. The plurality of masks comprises the reference mask and the target mask. The masks may identify specific features within the images, such as geological formations, faults, resource deposits, etc. Applying the masks to the images may highlight and isolate areas of interest within the images.

The process (200) may further include presenting an output volume comprising a three-dimensional view of subsurface data generated using the target mask. The output volume may be presented by transmitting the representation of the output volume to a client device that displays the output volume.

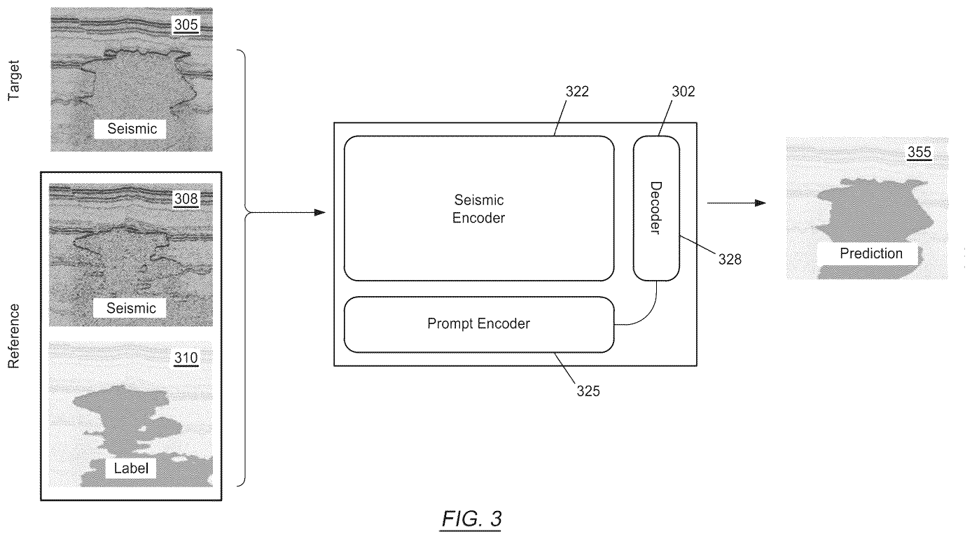

Turning to FIG. 3, in the context of seismic data processing, the model application (302) is an informed feature extraction foundation model that processes the reference image (308) (referred to as a reference seismic), the target image (305) (referred to as a target seismic), and the reference mask (310) (referred to as a reference label) to generate the target mask (355) (referred to as a prediction). The model application (302) includes the feature encoder (322) (referred to as a seismic encoder), the prompt encoder (325), and the mask decoder (328) (referred to as a decoder).

The target image (305) and the reference image (308) are slices of subsurface data from a volume of subsurface information. The reference mask (310) identifies features within the reference image (308) that are of interest within the volume from which the reference image (308) was extracted.

The model application (302) is composed of three major parts, namely the feature encoder (322) (referred to as a seismic encoder), prompt encoder (325), and the mask decoder (328) (referred to as a decoder). The feature encoder (322) may take in two seismic images at a time, including the reference image (308) (referred to as a reference seismic) and the target image (305) (referred to as a target seismic). The reference image (308) may be presented as an example, where a user may dynamically interact with and extract a geofeature of interest with the reference mask (310) (referred to as a reference label). The target image (305) will be automatically interpreted by the model application (302) following the intention of the user as expressed in the reference mask (310). The reference image (308) and the target image (305) may be stacked in batch and processed independently by the feature encoder (322). The input to the prompt encoder is the reference mask (310), which is a 2D mask corresponding to the reference image (208) forming a one shot interpretation result for the reference image (308) by the user. The reference mask (310) delineates the features (also referred to as target objects) to be segmented in the volume from which the reference image (308) and the target image (305) are extracted. The reference mask (310) defines the intention that is processed and understood by the prompt encoder (325). The outputs of both feature encoder (322) and the prompt encoder (325) are integrated by the mask decoder (328). The mask decoder (328) projects the intention extracted from the reference mask (also referred to as a prompt mask), understands the correlations between the reference image (308) and the target image (305), and delineates the same objects on the target image (305) with pixel wise accuracy that were delineated in the reference image (308) by the reference mask (310). The feature encoder (322) may be a vision transformer (ViT) and the prompt encoder (325) may be composed of convolutional layers. The mask decoder (328) may be constructed by a small two-way transformer that primarily merges the information between the two seismic embeddings and correlates the seismic embeddings (which are output from the feature encoder (322)) with the mask embeddings output from the prompt encoder (325). The seismic embeddings output from the feature encoder (322) may include a reference feature embedding and a target feature embedding that are respectively generated from the reference image (308) and the target image (305). The mask embedding may include a reference mask embedding generated from the reference mask (310) by the prompt encoder (325).

The model application (302) may be constructed in two stages. In a first stage, the feature encoder (322) may be trained to understand the seismic features and project the original seismic images (e.g., the reference image (308) and the target image (305)) into a representative space (e.g., into the space of the reference feature embedding and the target feature embedding). The feature encoder (322) may be pretrained. The feature encoder (322) is combined with smaller decoders, and trained with self supervised learning tasks, such as image reconstruction and denoising. In a second stage, the model application (302), including feature encoder (322), the prompt encoder (325), and the mask decoder (328) is trained with both self supervised and supervised tasks, i.e., the segmentation of a random geofeature using the reference as an example.

In the inference phase, i.e., during the use of the model application (302), the objective is to extract a complete geofeature from a 3D seismic volume, e.g., by processing each of the slices from the volume as a target image using the model application (302). One slice of the input volume may be selected as the reference image (308). A random feature may be labelled interactively to generate a reference mask (310). Using the selected reference image (308) and mask (310) (also respectively referred to as the reference seismic and label) as the reference pair, the model application (302) may understand the seismic patterns as well as the target geofeature identified in the reference image by the reference mask, perform the same segmentation task for the rest of the slice of the volume, and extract a 3D geobody. The process does not require intensive labelling and finetuning for the model application (302). An inference only style can be achieved for any temporarily defined geofeature.

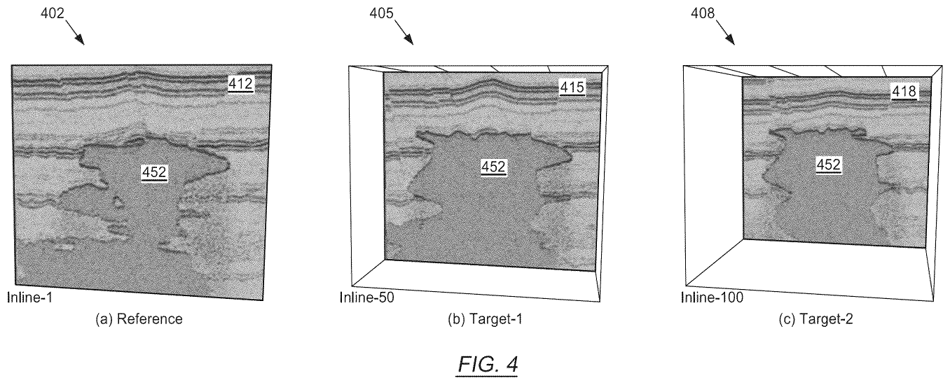

Turning to FIG. 4, in the context of seismic data processing, the outputs of a model application may be displayed on a user interface to show features in different slices of a volume. For example, the user interface (402) displays the image (412) at a first slice of a volume. The user interface (405) is updated from the user interface (402) to display the image (415) for a different slice of the same volume. The user interface (408) is updated from the user interface (405) to display the image (418) at yet a different slice of the same volume of subsurface data. A single three-dimensional feature (452) is displayed in the different images (412), (415), and (418) for the different slices of the volume. The image (412) may be the reference image used to generate the images (415) and (418) as target images using the model application.

Embodiments may be implemented on a special purpose computing system specifically designed to achieve the improved technological result. Turning to FIG. 5.1 and FIG. 5.2, the special purpose computing system (500) may include one or more computer processors (502), non persistent storage (504), persistent storage (506), a communication interface (512) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores or micro-cores of a processor. The computer processor(s) (502) includes one or more processors. The one or more processors may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (508). The inputs may include text input, audio input, video input, etc., which may be processed and transmitted by the computing system (500) in accordance with the disclosure. The communication interface (512) may include an integrated circuit for connecting the computing system (500) to a network (not shown) (e.g., a local area network (LAN), a wide area network (WAN) such as the Internet, mobile network, or any other type of network), and/or to another device, such as another computing device.

Further, the output device(s) (508) may include a display device, a printer, external storage, or any other output device. One or more of the output device(s) (508) may be the same or different from the input device(s) (510). The input device(s) (510) and the output device(s) (508) may be locally or remotely connected to the computer processor(s) (502). Many different types of computing systems exist, and the aforementioned input device(s) (510) and output device(s) (508) may take other forms. The output device(s) (508) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (500) in FIG. 5.1 may be connected to or be a part of a network. For example, as shown in FIG. 5.2, the network (520) may include multiple nodes (e.g., node X (522) and node Y (524)). Each node may correspond to a computing system, such as the computing system (500) shown in FIG. 5.1, or a group of nodes combined may correspond to the computing system (500) shown in FIG. 5.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526), including receiving requests and transmitting responses to the client device (526). For example, the nodes may be part of a cloud computing system. The client device (526) may be a computing system, such as the computing system (500) shown in FIG. 5.1. Further, the client device (526) may include and/or perform all or a portion of one or more embodiments of the disclosure.

The computing system (500) of FIG. 5.1 may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or a semi permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
processing a reference image and a target image using a feature encoder model to generate feature encoder output;
processing a reference mask using a prompt encoder model to generate a prompt encoder output; and
processing the feature encoder output and the prompt encoder model output using a mask decoder model to generate a target mask.

2. The method of claim 1, further comprising:
generating a plurality of images from an input volume,
wherein the plurality of images comprises the reference image and the target image.

3. The method of claim 1, further comprising:
generating a plurality of images from an input volume,
wherein the input volume comprises a three-dimensional view of subsurface data.

4. The method of claim 1, further comprising:
generating an output volume from a plurality of images and a plurality of masks,
wherein the plurality of masks comprises the reference mask and the target mask.

5. The method of claim 1, wherein processing the reference image and the target image using the feature encoder model to generate feature encoder output comprises:
generating a reference feature embedding from the reference image with the feature encoder model using self-attention.

6. The method of claim 1, wherein processing the reference image and the target image using the feature encoder model to generate feature encoder output comprises:
generating a target feature embedding from the target image with the feature encoder model using self-attention.

7. The method of claim 1, wherein processing the reference mask using the prompt encoder model to generate the prompt encoder output comprises:
generating a reference mask embedding from the reference mask with the prompt encoder model using a convolutional neural network.

8. The method of claim 1, wherein processing the feature encoder output and the prompt encoder output using the mask decoder model to generate the target mask comprises:
querying the reference feature embedding with the reference mask embedding to generate an intermediate mask embedding using a reference cross attention block in the mask decoder model.

9. The method of claim 1, wherein processing the feature encoder output and the prompt encoder output using the mask decoder model to generate the target mask comprises:
querying the target feature embedding with an intermediate mask embedding to generate the target mask using a target cross attention block in the mask decoder model.

10. The method of claim 1, further comprising:
presenting an output volume comprising a three-dimensional view of subsurface data generated using the target mask.

11. A system comprising:
at least one processor; and
an application that, when executing on the at least one processor, performs stored operations comprising:
processing a reference image and a target image using a feature encoder model to generate feature encoder output,
processing a reference mask using a prompt encoder model to generate a prompt encoder output, and
processing the feature encoder output and the prompt encoder model output using a mask decoder model to generate a target mask.

12. The system of claim 11, wherein the application performs stored operations further comprising:
generating a plurality of images from an input volume,
wherein the plurality of images comprises the reference image and the target image.

13. The system of claim 11, wherein the application performs stored operations further comprising:
generating a plurality of images from an input volume,
wherein the input volume comprises a three-dimensional view of subsurface data.

14. The system of claim 11, wherein the application performs stored operations further comprising:
generating an output volume from a plurality of images and a plurality of masks,
wherein the plurality of masks comprises the reference mask and the target mask.

15. The system of claim 11, wherein processing the reference image and the target image using the feature encoder model to generate feature encoder output comprises:
generating a reference feature embedding from the reference image with the feature encoder model using self-attention.

16. The system of claim 11, wherein processing the reference image and the target image using the feature encoder model to generate feature encoder output comprises:
generating a target feature embedding from the target image with the feature encoder model using self-attention.

17. The system of claim 11, wherein processing the reference mask using the prompt encoder model to generate the prompt encoder output comprises:
generating a reference mask embedding from the reference mask with the prompt encoder model using a convolutional neural network.

18. The system of claim 11, wherein processing the feature encoder output and the prompt encoder output using the mask decoder model to generate the target mask comprises:
querying the reference feature embedding with the reference mask embedding to generate an intermediate mask embedding using a reference cross attention block in the mask decoder model.

19. The system of claim 11, wherein processing the feature encoder output and the prompt encoder output using the mask decoder model to generate the target mask comprises:
querying the target feature embedding with an intermediate mask embedding to generate the target mask using a target cross attention block in the mask decoder model.

20. A non-transitory computer readable medium comprising stored instructions executable by at least one processor to perform:
processing a reference image and a target image using a feature encoder model to generate feature encoder output;
processing a reference mask using a prompt encoder model to generate a prompt encoder output; and
processing the feature encoder output and the prompt encoder model output using a mask decoder model to generate a target mask.
